(19) United States
(12) Patent Application Publication
(10) Pub. No.: US 2007/0158207 A1
(43) Pub. Date: Jul. 12, 2007

(54) Methods for electrochemical processing with pre-biased cells

(75) Inventors: Jie Diao, San Jose, CA (US); Renhe Jia, Berkeley, CA (US); You Wang, Cupertino, CA (US); Gerald John Alonzo, Los Gatos, CA (US); Stan D. Tsai, Fremont, CA (US); Lakshmanan Karuppiah, San Jose, CA (US)

Correspondence Address: PATTERSON & SHERIDAN, LLP, 3040 POST OAK BOULEVARD, SUITE 1500, HOUSTON, TX, 77056, US

(73) Assignee: Applied Materials, Inc.

(21) Appl. No.: 11/326,647

(22) Filed: Jan. 6, 2006

(51) Int. Cl. B23H 3/00

(52) U.S. Cl. 205/641

(57) ABSTRACT

A method for electrochemically processing a substrate is provided. In one embodiment, the method includes performing a conditioning procedure on a processing pad having a plurality of process cells, energizing the process cells by applying a voltage to the conditioned processing pad, placing a substrate having at least a conductive layer disposed thereon on the energized pad, and removing at least a portion of the conductive layer in the energized process cells. In another embodiment, a method for polishing a substrate includes placing an unused conductive pad having a plurality of process cells on a platen of a processing system, breaking in the pad on the platen, energizing the process cells by applying a voltage to the broken-in pad, placing a substrate having at least a conductive layer disposed thereon on the energized pad, and removing at least a portion of the conductive layer in the energized cells.

### BACKGROUND OF THE INVENTION

1. Field of the Invention

Embodiments of the present invention generally relate to a method for electrochemically processing a substrate. More specifically, the present application provides methods for electrochemically processing a substrate on pre-biased cells.

2. Description of the Related Art

Electrochemical Mechanical Processing (ECMP) is a technique used to deposit or remove conductive materials from a substrate surface. For example, in an ECMP polishing process, conductive materials are removed from the surface of a substrate by electrochemical dissolution while concurrently polishing the substrate with reduced mechanical abrasion as compared to conventional Chemical Mechanical Polishing (CMP) processes, which typically rely on abrasive qualities of the pad material, or an abrasive slurry, for removal. While these processes may be used for the same purpose, the ECMP process is sometimes preferred because of low shear forces and reduced dishing of planarized features.

Electrochemical dissolution is typically performed by applying an electrical bias between a cathode and the feature side i.e., deposit receiving surface of a substrate. The feature side of the substrate may have a conductive material that has been deposited by a deposition method such as, chemical vapor deposition (CVD), plasma enhanced chemical vapor deposition (PECVD), atomic layer deposition (ALD), electrochemical plating (ECP), or any method known in the art. The bias may be applied to the substrate by a conductive contact element disposed on or through a polishing material upon which the substrate is processed, and the conductive materials may be removed from the feature side of the substrate into a surrounding electrolyte.

In some systems, a conductive polishing pad is used to apply the bias to the feature side of the substrate. Relative motion between the substrate and the conductive polishing pad may be provided to enhance the removal of the conductive material from the substrate. The conductive material is removed until an endpoint is reached, which may be determined by monitoring charge and/or current. After a number of substrates have been polished, polishing by-product, residue or other contaminants may accumulate on the conductive polishing pad surface thereby reducing the conductivity of the polishing pad. As the electrical property of the pad diminishes, polishing performance is lost. Thus, the pad surface must periodically be refreshed, or conditioned, to restore the performance of the pad and quality polishing of the substrate.

After conditioning, the conductivity between the pad surface and the substrate is high. Thus, as the voltage applied to the pad which is electrically coupled to the substrate, an in-rush current is generated. As only a portion of the in-rush current participates in the processing of the conductive layer, an error in the total charge and/or current monitored during endpoint detection may be generated. Errors in endpoint detection are undesirable as it may result in poor process quality and diminished process repeatability.

Thus, there is a need for an improved method for processing a substrate.

### SUMMARY OF THE INVENTION

Methods for electrochemically processing a substrate are provided. In one embodiment, the method includes performing a conditioning procedure on a processing pad having a plurality of process cells, energizing the process cells by applying a voltage to the conditioned processing pad, placing a substrate having at least a conductive layer disposed thereon on the energized pad, and removing at least a portion of the conductive layer in the energized process cells.

In another embodiment, a method for polishing a substrate includes placing an unused conducive pad having a plurality of process cells on a platen of a processing system, breaking in the pad, energizing the process cells by applying a voltage to the broken-in pad, placing a substrate having at least a conductive layer disposed thereon on the energized pad, and removing at least a portion of the conductive layer on the substrate in the energized cells.

In yet another embodiment, a method for polishing a substrate includes working conductive top surface of a conductive polishing pad to improve electrical properties, establishing a current flow between worked top surface and on electrode through an electrolyte thereby defining a plurality of process cells, placing a conductive surface of a substrate in contact with the cells, adjusting processing current flow through the cells, and electrochemically processing the conductive surface.

### BRIEF DESCRIPTION OF THE DRAWINGS

The teachings of the present invention can be readily understood by considering the following detailed description in conjunction with the accompanying drawings, in which:

FIG. 1 is a plan view of an electrochemical mechanical planarizing system;

FIG. 2 is a simplified side view of one embodiment of a polishing station of an ECMP system having a conditioning head of the present invention;

FIG. 3 is a plan view of a platen depicting the relative movements of the polishing and conditioning heads; and

FIG. 4 is a flow diagram of one embodiment of a method for electrochemical processing.

To facilitate understating, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

Embodiments of the present invention generally relate to methods for processing a substrate by utilizing pre-biased processing cells. The methods described herein advantageously reduce the in-rush current observed at the beginning of substrate polishing, which allow for more accurate endpoint control, reduced film damage, and process repeatability.

Exemplary Apparatus

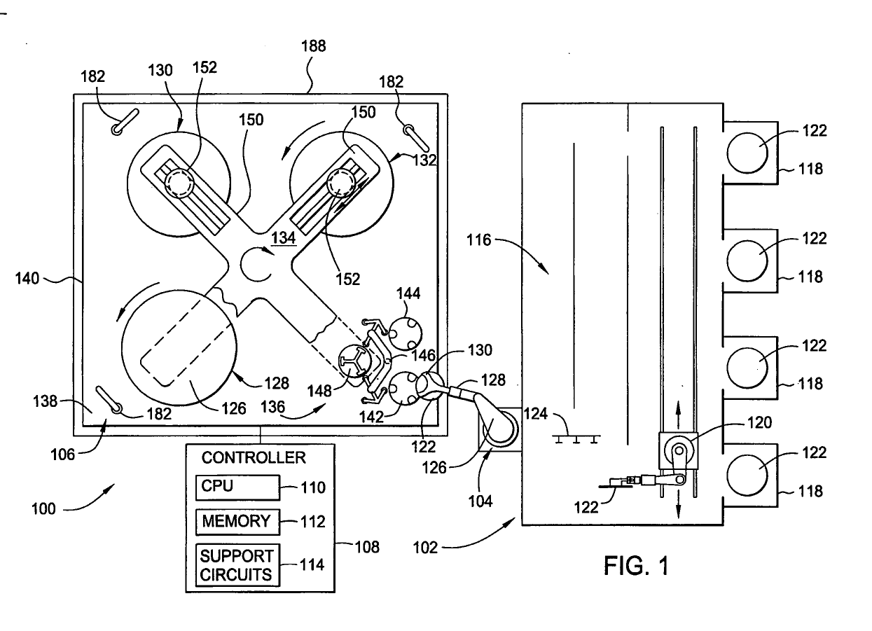

FIG. 1 is a plan view of one embodiment of a planarization system 100 having an apparatus for electrochemically processing a substrate. The exemplary system 100 generally comprises a factory interface 102, a loading robot 104, and a planarizing module 106. The loading robot 104 is disposed proximate the factory interface 102 and the planarizing module 106 to facilitate the transfer of substrates 122 therebetween.

A controller 108 is provided to facilitate control and integration of the modules of the system 100. The controller 108 comprises a central processing unit (CPU) 110, a memory 112, and support circuits 114. The controller 108 is coupled to the various components of the system 100 to facilitate control of, for example, the planarizing, cleaning, and transfer processes.

The factory interface 102 generally includes a cleaning module 116 and one or more wafer cassettes 118. An interface robot 120 is employed to transfer substrates 122 between the wafer cassettes 118, the cleaning module 116 and an input module 124. The input module 124 is positioned to facilitate transfer of substrates 122 between the planarizing module 106 and the factory interface 102 by grippers, for example vacuum grippers or mechanical clamps (not shown).

The planarizing module 106 includes at least a first electrochemical mechanical planarizing (ECMP) station 128, disposed in an environmentally controlled enclosure 188. Examples of planarizing modules 106 that can be adapted to benefit from the invention include MIRRA® Chemical Mechanical Planarizing Systems, MIRRA MESA™ Chemical Mechanical Planarizing Systems, REFLEXION® Chemical Mechanical Planarizing Systems, REFLEXION® LK Chemical Mechanical Planarizing Systems, and REFLEXION LK ECMP™ Chemical Mechanical Planarizing Systems, all available from Applied Materials, Inc. of Santa Clara, Calif. Other planarizing modules, including those that use conductive polishing pads, planarizing webs, or a combination thereof, and those that move a substrate relative to a planarizing surface in a rotational, linear or other planar motion may also be adapted to benefit from the invention.

In the embodiment depicted in FIG. 1, the planarizing module 106 includes one bulk ECMP station 128, a second ECMP station 130 and third polishing station 132. The third polishing station may be an ECMP station as described for ECMP stations 128 or 130 as shown in FIG. 1, and may alternatively, be a chemical mechanical polishing (CMP) station. As CMP stations are conventional in nature, further description thereof has been omitted for the sake of brevity. However, an example of a suitable CMP polishing station is more fully described in U.S. Pat. No. 5,738,574, issued on Apr. 14, 1998, entitled, “Continuous Processing System for Chemical Mechanical Polishing,” the entirety of which is incorporated herein by reference to the extent not inconsistent with the invention.

Bulk removal of conductive material from the substrate is performed through an electrochemical dissolution process at the bulk ECMP station 128. After the bulk material removal at the bulk ECMP station 128, residual conductive material is removed from the substrate at the residual ECMP station 130 through a second electrochemical mechanical process. It is contemplated that more than one residual ECMP stations 130 may be utilized in the planarizing module 106. Barrier layer material may be removed at polishing station 132 after processing at the residual ECMP station 130. Alternatively, each of the first and second ECMP stations 128, 130 may be utilized to perform single step or two step conductive material removal on a single station. One example of a planarizing module for a two step conductive material removal process, such as for tungsten removal, is disclosed in U.S. Patent Provisional Application Ser. No. 60/648,131, filed on Jan. 28, 2005, and U.S. patent application Ser. No. 11/130,032, filed on May 16, 2005, both of which are incorporated by reference to the extent not inconsistent with the claimed aspects and description herein.

The exemplary planarizing module 106 also includes a transfer station 136 and a carousel 134 that are disposed on an upper or first side 138 of a machine base 140. In one embodiment, the transfer station 136 includes an input buffer station 142, an output buffer station 144, a transfer robot 146, and a load cup assembly 148. The input buffer station 142 receives substrates from the factory interface 102 by means of the loading robot 104. The loading robot 104 is also utilized to return polished substrates from the output buffer station 144 to the factory interface 102. The transfer robot 146 is utilized to move substrates between the buffer stations 142, 144 and the load cup assembly 148.

In one embodiment, the transfer robot 146 includes two gripper assemblies (not shown), each having pneumatic gripper fingers that hold the substrate by the substrate's edge. The transfer robot 146 may simultaneously transfer a substrate to be processed from the input buffer station 142 to the load cup assembly 148 while transferring a processed substrate from the load cup assembly 148 to the output buffer station 144. An example of a transfer station that may be used to advantage is described in U.S. Pat. No. 6,156,124, issued Dec. 5, 2000 to Tobin, which is herein incorporated by reference in its entirety.

The carousel 134 is centrally disposed on the base 140. The carousel 134 typically includes a plurality of arms 150, each supporting a carrier head assembly 152. The head assemblies 152 retain the substrate during processing. Two of the arms 150 depicted in FIG. 1 are shown in phantom such that the transfer station 136 and a planarizing surface 126 of the first ECMP station 128 may be seen. The carousel 134 is indexable such that the carrier head assemblies 152 may be moved between the planarizing stations 128, 130, 132 and the transfer station 136. One carousel that may be utilized to advantage is described in U.S. Pat. No. 5,804,507, issued Sep. 8, 1998 to Perlov, et al., which is hereby incorporated by reference in its entirety.

A conditioning device 182 is disposed on the base 140 adjacent each of the planarizing stations 128, 130, 132. The conditioning device 182 periodically conditions the planarizing material disposed in the stations 128, 130, 132 to maintain uniform planarizing results.

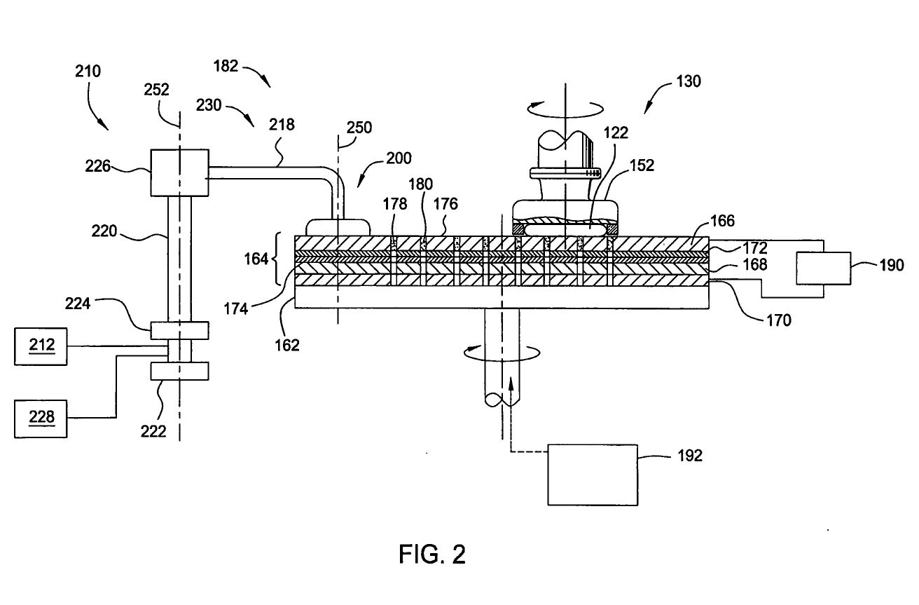

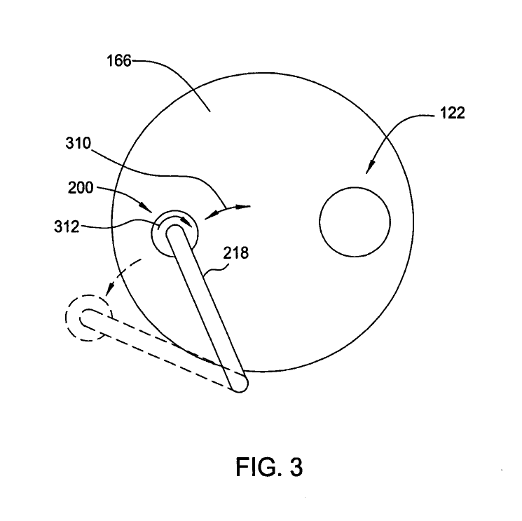

FIG. 2 is a simplified side view of a polishing station 130 of an ECMP system having a conditioning head 200 supported by a support assembly 210 coupled to the base (not shown). Support assembly 210 is adapted to position the conditioning head 200 in contact with the polishing pad 166 and further is adapted to provide a relative motion therebetween. The conditioning head 200 generally rotates and/or moves laterally across the surface of the polishing pad 166 as indicated by arrows 310 and 312 in FIG. 3.

The polishing station, such as 130 or 128, in a ECMP system generally includes a platen 162 that supports a fully conductive polishing pad assembly 164. The platen 162 may be configured to deliver electrolyte through the conductive polishing pad assembly 164 from an electrolyte source 192, or the platen 162 may have a fluid delivery arm (not shown) coupled to a processing fluid source (not shown) disposed adjacent thereto configured to supply electrolyte to a planarizing surface of the conductive polishing pad assembly 164. Alternatively, the electrolyte may be provided to the surface of the polishing pad 166 by, for example, a nozzle (not shown). The platen assembly 162 may include at least one of a meter or sensor to facilitate endpoint detection.

In one embodiment, the conductive polishing pad assembly 164 includes interposed pad 168 sandwiched between a conductive pad 166 and an electrode 170. The conductive pad 166 is substantially conductive across its top processing surface and is generally made from a conductive material or a conductive composite, for example, the conductive elements are dispersed integrally with or comprise the material comprising the planarizing surface, such as a polymer matrix having conductive particles dispersed therein or a conductive coated fabric, among others. The conductive pad 166, the interposed pad 168, and the electrode 170 may be fabricated into a single, replaceable assembly. The conductive polishing pad assembly 164 is generally permeable or perforated to allow electrolyte to pass between the electrode 170 and top surface 176 of the conductive pad 166. In the embodiment depicted in FIG. 2, the conductive polishing pad assembly 164 is perforated by a plurality of apertures 178 to allow electrolyte to flow therethrough. The apertures 178 may be partially or fully filled with electrolyte to provide a conductive path between the substrate and electrode, thereby defining process cells 180 to drive the polishing of the substrate. In one embodiment, the conductive pad 166 is comprised of a conductive material disposed on a polymer matrix disposed on a conductive fiber, for example, tin particles in a polymer matrix disposed on a woven copper coated polymer.

A conductive foil 172 may additionally be disposed between the conductive pad 166 and the subpad 168. The foil 172 is coupled to a power source 190 and provides uniform distribution of voltage applied by the source 190 across the conductive pad 166. In embodiments not including the conductive foil 172, the conductive pad 166 may be coupled directly, for example, via a terminal integral to the pad 166, to the power source 190. Additionally, the pad assembly 164 may further include an interposed pad 174, disposed adjacent the conductive pad 166, which, along with the foil 172, to provide mechanical strength to the overlying conductive pad 166. Examples of suitable pad assemblies are described in the previously incorporated U.S. patent application Ser. No. 10/455,941, filed on Jun. 6, 2003, and U.S. patent application Ser. No. 10/455,895, filed on Jun. 6, 2003, both of which are hereby incorporated by reference to the extent not inconsistent with the claims aspects and description herein. Another example of a conductive polishing pad they may be used in the pad assembly is described in U.S. Patent Provisional Application Ser. No. 60/616,028, filed on Oct. 5, 2004, which is hereby incorporated by reference to the extent not inconsistent with the claims aspects and description herein.

The polishing station 130 of an ECMP system having a conditioning head 200 supported by a support assembly 210 coupled to the base (not shown). Support assembly 210 is adapted to position the conditioning head 200 in contact with the polishing pad 166 and further is adapted to provide a relative motion therebetween. The conditioning head 200 generally rotates and/or moves laterally across the surface of the polishing pad 166 as indicated by arrows 310 and 312 in FIG. 3.

In one embodiment, the conditioning head 200 includes a conditioning surface adapted to contact the polishing pad 166. The conditioning head 200 is typically disk shaped and comprises a conditioning surface adapted to contact the surface of the polishing pad 166. In one embodiment, the conditioning surface comprises abrasive particles coupled to, or deposited on, the conditioning surface. Suitable abrasives particles include inorganic abrasives, polymeric abrasives, and combinations thereof. Inorganic abrasive particles that may be used include, but are not limited to, silica, silicon carbide, alumina, zirconium oxide, titanium oxide, cerium oxide, germania, or any other abrasives of metal oxides, known or unknown, including abrasive material used in fixed abrasive polishing articles. Prior to coupling the abrasive particles, the conditioning surface may be roughened to promote bonding. The abrasive particles may be deposited on the conditioning surface and bound by a process resistant adhesive.

Alternatively, a conditioning film may be formed from a matrix of abrasive particles intermixed in a polymeric binder. After curing, the conditioning film may be cut to a suitable size and coupled to the conditioning surface by a process resistant binder. In one embodiment, the conditioning surface of the conditioning head is adapted to removably couple to the conditioning head 200 to facilitate replacement of the conditioning surface after use.

In another embodiment, the conditioning head 200 includes a conditioning surface adapted to contact the surface of the polishing pad 166 wherein the material of the conditioning surface is abraded or roughened by a machining process and/or sandblasting to create a textured conditioning surface. The conditioning surface may also be formed by machining or embossing a grooved surface in the material of the conditioning surface. The grooved surface may be formed in any pattern, such as a grid or X-Y pattern, a cross-hatch pattern, a parallel pattern, or combinations thereof, and the grooved surface may further be textured as described herein. Additionally the grooves of the grooved surface may machined or embossed to form grooves with angles at the surface of the conditioning surface adapted to form a plurality of cutting edges in the conditioning surface. The cutting edges, i.e., where the corners or edges of the grooves contact the polishing pad further condition the polishing pad surface.

The conditioning head 200 spins and sweeps the pad surface during the substrate polishing to perform in-situ pad cleaning as shown by arrows 310, 312 in FIG. 3. The support assembly 210 moves the conditioning head 200 into position over the surface of the polishing pad 166. The support assembly 210 then lowers the conditioning head 200 against the surface of the polishing pad 166 with a down-force in the range of from about 0.01 to about 2 pound per square inch (psi), such as between about 1.0 psi and about 2 psi, for example, about 1.5 psi.

Materials for the conditioning surface of the conditioning head 200 may include a ceramic material, a metal material, such as stainless steel, tungsten, nickel, or combinations thereof, a polymeric material including hard plastics, such as polyphenylene sulfide (PPS), and combinations of the materials described herein.

In another embodiment, the conditioning head 200 includes a brush-type conditioning surface. The brush-type conditioning surface is adapted to contact the surface of the polishing pad 166. The brush-type conditioning surface may be made from materials, such as metals, including stainless steel, tungsten, nickel, or polymeric materials, such as nylon, or combinations thereof. The brush-type conditioning surface may be formed on, or coupled to the conditioning surface of the conditioning head 200.

In another embodiment, the conditioning head 200 may comprise a replaceable conditioning element, such as a diamond disk, coupled to a conditioning head that is movable over the polishing surface. The abrasive disk is lowered into contact with the polishing surface while being rotated. One example of a conditioning head is described in U.S. patent application Ser. No. 10/411,752, filed on Apr. 10, 2003, which is hereby incorporated by reference to the extent not inconsistent with the claims aspects and description herein. An alternative conditioning head comprising a brush type conditioning head is disclosed in U.S. Patent Provisional Application Ser. No. 60/604,209, filed on Aug. 24, 2004, which is hereby incorporated by reference to the extent not inconsistent with the claims aspects and description herein.

The lateral motion of the conditioning head 200 may be linear or along an arc in a range of from about the center of the polishing pad 166 to about the outer edge of the polishing pad 166, such that, in combination with the rotation of the polishing pad 166, the entire surface of the polishing pad 166 may be conditioned. The conditioning head 200 may have a further range of motion to move the conditioning head 200 beyond the edge of the polishing pad 166, for example, when not in use (as shown in phantom in FIG. 3). One example of a support assembly that may be modified to use with the conditioning head 200 is described in U.S. Pat. No. 6,702,651, issued Mar. 9, 2004, to Tolles, et al., and which is hereby incorporated by reference.

In one embodiment, the support assembly 210 includes a stanchion 220 coupled to the base (not shown) and a support arm 218 coupled to the stanchion 220. The support arm 218 cantilevers the conditioning head 200 over the polishing pad 166. A motor 226 may be utilized to rotate the conditioning head 200 about an axis 250 and an actuator 224 may selectively raise and lower the conditioning head 200 relative to the polishing pad 166. Another actuator 222 may be used to rotate the support arm 218, and hence, the conditioning head 200, relative to an axis 252. The actuator 222 may be used to move the conditioning head 200 to the side of the polishing pad 166 when not in use and also may hold in one position or oscillate the conditioning head 200 between two points on the polishing pad 166 during pad cleaning operations.

A conditioning composition source 212 is coupled to the conditioning head 200 through the support assembly 210 to provide a conditioning composition to the conditioning head 200. A vacuum supply 228 is also coupled to the conditioning head 200 through the support assembly 210 to remove cleaning waste from the conditioning head 200.

The conditioning head 200 may be used to break-in an unused polishing pad 166 before a polishing process, or to break-in a polishing pad 166 after a significant period of inactivity. (i.e., no processing). The conditioning head 200 may also used to condition the polishing pad 166 during (in-situ) processing of a substrate and/or after (ex-situ) substrate processing (i.e., condition between processing substrates).

Conditioning Composition

In one embodiment, a conditions composition may be applied to the pad during conditioning. The conditioning composition is formulated to dissolve polishing by-product and/or clean the pad during conditioning. In one aspect of the invention, for cleaning conductive polishing pads utilized for conductive material polishing, such as tungsten and/or copper polishing, the conditioning composition may be amine solutions, one carboxylic acid solutions and their combination with amines, and the like. The pH value can be adjusted to be similar to that of the main processing fluid so that it does not affect the polishing performance in the event that the conditioning composition is mixed in with the polishing fluid.

In another aspect of the invention, a conditioning composition suitable for cleaning and/or conditioning a polishing pad 166 during copper electrochemical mechanical processing is described below. The conditioning composition dissolves the conductive material precipitate, such as copper precipitate, thus assisting in refurbishing the processing tool and restoring polishing performance. The conditioning composition can be an acid, basic, or neutral water solution. The conditioning composition may also be a combination of acids and bases as described herein. The pH of the cleaning solution may be adjusted by the addition of organic or inorganic acids to a range of from about 5 to about 11.

For an acid-based conditioning composition, the acid may be inorganic or organic. Suitable inorganic acids include phosphoric, sulfuric, and nitric acids. The inorganic acids may have a concentration in the range of from about 0.1 to about 2 percent. Suitable organic acids include acetic, citric, adipic, lactic, and malic acids having a concentration in the range of from about 0.1 to about 5 percent.

For a base-based conditioning composition, the base may also be inorganic or organic. Suitable inorganic bases include ammonium hydroxide and potassium hydroxide having a concentration in the range of from about 0.1 to about 2 percent. Suitable organic bases include ethylenediamine (EDA), diethylenetriamine (DETA), and ethylenediamine tetraacetic acid (EDTA) having a concentration in the range of from about 0.1 to about 5 percent.

The conditioning composition may also include organic acid salts. Suitable organic salts include ammonium citrate, ammonium tartarate, ammonium succinate, or their potassium derivatives having a concentration in the range of from about 0.1 to about 10 percent. The conditioning composition may also include one or more inorganic or organic acids. Suitable inorganic or organic acids include acetic acid, phosphoric acid, citric acid, and oxalic acid, either alone or in combination, having a total concentration in the range of from about 0.1 to about 7 percent.

In one embodiment, the composition of a conditioning composition includes an acetic acid-based system having from about 0.5 to about 5 percent EDA and a pH in the range of from about 5 to about 11. In another embodiment, the above composition has a concentration of EDA in the range of from about 1 to about 3 percent. In yet another embodiment, the concentration of EDA is about 2 percent. Another embodiment of the above conditioning composition has a pH in the range of from about 7 to about 10. Yet another embodiment has a pH in the range of from about 9 to about 10. The pH of the system may be adjusted by controlling the amount of acetic acid in the system.

In another embodiment, the composition of a conditioning composition includes a citric acid-based system having from about 0.5 to about 5 percent EDA and a pH in the range of from about 5 to about 11. In another embodiment, the above composition has a concentration of EDA in the range of from about 1 to about 3 percent. In yet another embodiment, the concentration of EDA is about 2 percent. Another embodiment of the above conditioning composition has a pH in the range of from about 7 to about 10. Yet another embodiment has a pH in the range of from about 9 to about 10. The pH of the system may be adjusted by controlling the amount of citric acid in the system.

Other compatible components may be added to the conditioning composition to protect a conductive material surface of the polished substrate, such as a corrosion inhibitor. Examples of suitable corrosion inhibitors include benzotriazole (BTA), mercaptobenzotriazole, or 5-methyl-1-benzotriazole (TTA). The corrosion inhibitor may have a total concentration of from about 0.1 percent to about 0.3 percent. For example, from about 0.1 to about 0.3 percent BTA may be added to 0.5 percent EDA in a solution having a pH in the range of from about 5 to about 7 for acetic acid or citric acid.

Although this conditioning composition is described as being applied via the conditioning head 200, it is contemplated that other methods of application may be equally utilized for cleaning copper precipitate in processing systems. For example, the conditioning composition may be sprayed onto the polishing pad and other components of the processing system then subsequently rinsed using a high-pressure DI water rinsing spray. Alternatively, the cleaning solution may be fed through passages in the polishing pad to the surface of the pad.

Electrochemical Polishing Process

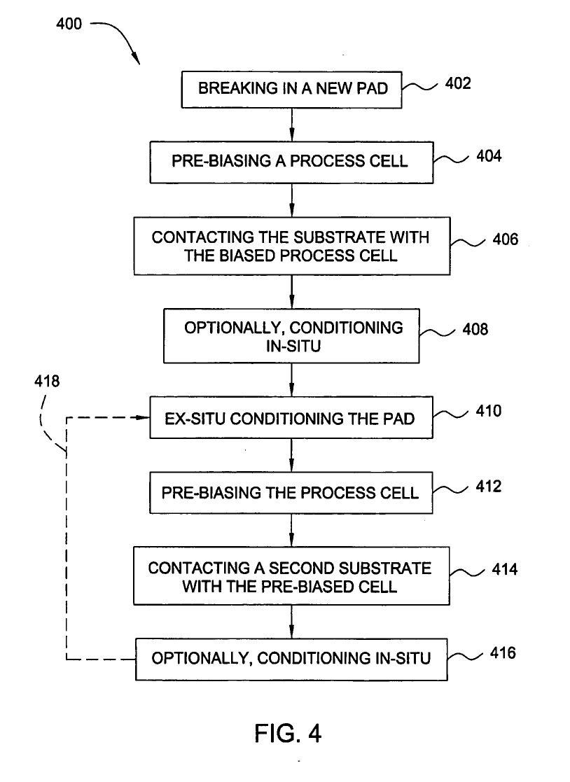

FIG. 4 is a flow diagram of one embodiment of an electrochemical polishing process 400. The process 400 may be practiced in an apparatus as described and shown in FIG. 2. It is contemplated that the method 400 described herein may be practiced on other systems.

In one embodiment, the process 400 begins at step 402 with breaking in a new (e.g., unused) processing pad disposed on the platen. After the processing pad broken-in, the pad is energized. For example, a pre-bias is applied between the conductive element (e.g., pad top surface) and the electrode thereby energizing the processing cells 180 prior to the substrate being placed in contact with the conditioned pad surface at step 404. Subsequent to the pre-biasing step 404, the substrate is placed in contact with the polishing cell to process (e.g., polish/planarize) a conductive layer on the substrate surface at step 406. Optionally, in-situ conditioning may be performed during the polishing process at step 408.

After the substrate polishing process has been performed, the polished substrate is removed from the polishing apparatus. An ex-situ, i.e., between substrate polishing, pad conditioning may be performed to remove the polishing by-product, residue, or other contaminants accumulated on the pad surface at step 410. In one embodiment, the ex-situ pad conditioning may be performed after processing each substrate. In another embodiment, the ex-situ pad conditioning may be performed after a predetermined number of substrates have been polished. In yet another embodiment, the ex-situ pad conditioning may be performed as needed.

Following the ex-situ pad conditioning, the pad is energized to pre-bias the process cells at step 412. After the pre-biasing, another substrate is placed in the polishing apparatus and contacted on the polishing pad to perform a polishing process at step 414. Optionally, in-situ conditioning may be performed during the polishing process of step 414 at step 416.

Once the polishing process has been performed, the polished substrate is removed from the polishing apparatus. Alternatively, the process steps 410, 412, 414, 416 may be repeated to process a batch of substrates as indicated by loop 418, illustrated in FIG. 4.

The process cells 180 disposed on the conductive processing pad may be pre-biased by applying a voltage from the power source 190 to eliminate the in-rush current concurrently with or after the polishing composition (e.g., electrolyte) being provided. In other words, the substrate is contacted to the polishing surface after the in-rush current has diminished and/or subsided.

Applying the voltage to the conductive pad energizes the process cells on the processing pad. The electrolyte in the cells serves as an electrical path between the electrode and the newly conditioned conductive pad thereby allowing a current to be established. After the process cells have been pre-biased for a predetermined period, the newly conditioned conductive pad tends to form a passivation layer on the pad surface by electrochemical reaction occurred through the established current and the in-rush current is reduced correspondingly. In one embodiment, the passivation layer may be an oxidized layer forming from the reaction between the conductive pad surface and the electrolyte. In another embodiment, wherein the conductive surface of the pad includes a metal, such as tin, the passivation layer may be a metal oxide layer, such as a tin oxide layer. After the current has become substantially stabilized, the to-be-polished substrate is then placed in contact with the conductive pad and the polishing process is commenced. In one embodiment, the time set for stabilizing the current may be between about 0.01 second to about 40 seconds. In another embodiment, the time may be set between about 0.1 second to about 20 seconds. In yet another embodiment, the time may be set between about 3 seconds to about 10 second, for example, about 5 seconds. The voltage for pre-biasing the process cells may be at a predetermined value or according to the voltage used during conductive material removal in polishing process. In one embodiment, the voltage applied thereto may be set according to the voltage set in the subsequent conductive material removal step. In another embodiment, the voltage may be set within a range at about 0.1 V to about 10 V. In yet another embodiment, the voltage may be set within a range at about 1 V to about 5 V, for example, from about 1.5 V to about 3 V.

After the to-be-polished substrate is placed in contact with the conductive pad, the polishing (e.g., planarization) process begins. The first polishing fluid may be provided at a flow rate between about 50 and about 800 milliliters per minute, such as about 300 milliliters per minute, to the substrate surface.

An example of a polish fluid substrate for use in the conductive material removal step includes between about 1 wt % and about 10 wt % of phosphoric acid, between about 0.1 wt % and about 6 wt % of the at least one chelating agent, between about 0.01 wt % and about 1 wt % of the corrosion inhibitor, between about 0.5 wt % and about 10 wt % of an inorganic or organic salt, between about 0.2 wt % and about 5 wt % of an oxidizer, and between about 0.05 wt % and about 1 wt % of abrasive particulates. The polish fluid has a conductivity of between about 60 and about 64 milliSiemens/centimeter(mS/cm). The process may also be performed with a composition temperature between about 20° C. and about 60° C.

The substrate surface is pressed against the pad at a pressure less than about 2 pounds per square inch (lb/in² or psi) (13.8 kPa). The contact pressure may include a pressure of about 1 psi (6.9 kPa) or less, for example, between about 0.01 psi (69 Pa) and about 1 psi (6.9 kPa), such as between about 0.1 (0.7 kPa) psi and about 0.8 psi (5.5 kPa) or between about 0.1 (0.7 kPa) psi and less than about 0.5 psi (3.4 kPa). In one aspect of the process, a pressure of about 0.3 psi (2.1 kPa) or less is used.

Relative motion is provided between the substrate surface and the conductive pad assembly 164 to reduce or remove the bulk of the copper material disposed on the substrate. Relative motion is provided between the substrate surface and the conductive pad assembly 164. The conductive pad assembly 164 disposed on the platen is rotated at a platen rotational rate of between about 7 rpm and about 80 rpm, for example, about 28 rpm, and the substrate disposed in a carrier head is rotated at a carrier head rotational rate between about 7 rpm and about 80 rpm, for example, about 37 rpm. The respective rotational rates of the platen and carrier head are believed to provide reduced shear forces and frictional forces when contacting the polishing article and substrate. Both the carrier head rotational speed and the platen rotational speed may be between about 7 rpm and less than 40 rpm. In one aspect of the polishing process, the carrier head rotational speed may be greater than a platen rotational speed by a ratio of carrier head rotational speed to platen rotational speed of greater than about 1:1, such as a ratio of carrier head rotational speed to platen rotational speed between about 1.5:1 and about 12:1, for example between about 1.5:1 and about 3:1, to remove material from the substrate surface.

A first bias from a power source 190 is applied between the two electrodes. The bias may be transferred from a conductive pad and/or electrode to the substrate 122. The bias may be applied by an electrical pulse modulation technique providing at least anodic dissolution.

The first bias is generally provided to produce anodic dissolution of the conductive material from the surface of the substrate at a current density up and about 100 mA/cm² which correlates to an applied current of about 40 amps to process substrates with a diameter up and about 300 mm. For example, a 200 mm diameter substrate may have a current density between about 0.01 mA/cm² and about 50 mA/cm², which correlates to an applied current between about 0.01 A and about 20 A. The invention also contemplates that the bias may be applied and monitored by volts, amps and watts. For example, in one embodiment, the power supply may apply a power between about 0.01 watts and 100 wafts, a voltage between about 0.01 V and about 10 V, and a current between about 0.01 amps and about 10 amps. The bias between about 2.6 volts and about 3.5 volts, such as 3 volts, may be used as the applied bias in the electrochemical processing step.

The bias may be varied in power and application depending upon the user requirements in removing material from the substrate surface. For example, increasing power application has been observed to result in increasing anodic dissolution. The bias may also be applied by an electrical pulse modulation technique. Pulse modulation techniques may vary, but generally include a cycle of applying a constant current density or voltage for a first time period, then applying no current density or voltage or a constant reverse current density or voltage for a second time period. The process may then be repeated for one or more cycles, which may have varying power levels and durations. The power levels, the duration of power, an “on” cycle, and no power, an “off” cycle” application, and frequency of cycles, may be modified based on the removal rate, materials to be removed, and the extent of the polishing process. For example, increased power levels and increased duration of power being applied have been observed to increase anodic dissolution.

The removal of copper material from the substrate may be performed in one or more processing steps, for example, a single copper removal step or a bulk copper removal step and a residual copper removal step. Bulk material is broadly defined herein as any material deposited on the substrate in an amount more than sufficient to substantially fill features formed on the substrate surface. Residual material is broadly defined as any material remaining after one or more bulk or residual polishing process steps. Generally, in a two step process, the bulk removal during a first electrochemical mechanical polishing process removes at least about 50% of the conductive layer, preferably at least about 70%, more preferably at least about 80%, for example, at least about 90%. The residual removal during a second electrochemical mechanical polishing process removes most, if not all the remaining conductive material disposed on the barrier layer to leave behind the filled plugs.

The bulk conductive material removal electrochemical mechanical polishing process may be performed on a first polishing platen and the residual removal electrochemical mechanical polishing process on a second polishing platen of the same or different polishing apparatus as the first platen. In another embodiment of the two-step process, the residual removal electrochemical mechanical polishing process may be performed on the same platen with the bulk removal process. Any barrier material may be removed on a separate platen, such as the third platen in the apparatus described in FIG. 2. For example, the apparatus described above in accordance with the processes described herein may include three platens for removing copper material including, for example, a first platen to remove bulk material, a second platen for residual removal and a third platen for barrier removal and/or buffing the substrate surface. In such an apparatus, the bulk and the residual processes are electrochemical mechanical polishing processes and the barrier removal is a CMP process or another electrochemical mechanical polishing process. In another embodiment, three electrochemical mechanical polishing platens may be used to remove bulk material, residual removal and barrier removal.

It should be noted that the pre-biasing step, performed after the pad conditioning or an unused pad broken-in in the present application, may be executed in all ECMP process in the system, such as bulk removal polishing, barrier removal polishing, residual removal polishing, etc.

Thus, a method for polishing a substrate in ECMP system has been provided that advantageously improves the polishing performance of the substrate and reduces the inrush current observed at the beginning of the substrate polishing by pre-biasing the processing cells on the processing pad.

While the foregoing is directed to embodiments of the present invention, other and further embodiments of the invention may be devised without departing from the basic scope thereof, and the scope thereof is determined by the claims that follow.

What is claimed is:

1. A method for processing a substrate, comprising:
(a) performing a conditioning procedure on a processing pad having a plurality of process cells;
(b) energizing the process cells by applying a voltage to the conditioned processing pad;
(c) placing a substrate having at least a conductive layer disposed thereon on the energized pad; and
(d) removing at least a portion of the conductive layer in the energized process cells.

2. The method of claim 1, wherein the step of applying a voltage further comprising:
applying a voltage between about 0.1 volts and about 10 volts prior to placing the substrate on the pad.

3. The method of claim 1, wherein the step of applying a voltage further comprising:
applying a voltage to the processing pad between about 0.1 second and about 20 seconds prior to placing the substrate on the pad.

4. The method of claim 1, wherein the step of applying a voltage further comprising:
applying a voltage between about 1 volt and about 5 volts prior to placing the substrate on the pad.

5. The method of claim 1, further comprising:
repeating steps (a)-(b) after step (d);
placing a second substrate on the pad; and
removing at least a portion of the conductive layer of the second substrate in the energized cells.

6. The method of claim 1, wherein the step of removing at least a portion of the conductive layer further comprises:
performing an in-situ conditioning process.

7. The method of claim 1, wherein the step of performing a conditioning procedure comprises:
contacting the processing pad with a conditioning element comprising diamonds.

8. The method of claim 1, wherein the step of performing a conditioning procedure comprises:
contacting a brush-type conditioning element to the processing pad.

9. A method for polishing a substrate, comprising:
placing an unused conductive pad having a plurality of process cells on a platen of a processing system;
breaking in the unused pad;
energizing the process cells by applying a voltage to the broken-in pad;
placing a substrate having at least a conductive layer disposed thereon on the energized pad; and
removing at least a portion of the conductive layer in the energized cells.

10. The method of claim 9, wherein the step of applying a voltage further comprising:
applying a voltage between about 0.1 volt and about 10 volts prior to placing the substrate on the pad.

11. The method of claim 9, wherein the step of applying a voltage further comprising:
applying a voltage to the pad between about 0.1 second and about 20 seconds prior to placing the substrate on the pad.

12. The method of claim 9, wherein the step of applying a voltage further comprising:
applying a voltage between about 1 volt and about 5 volts prior to placing the substrate on the pad.

13. The method of claim 9, further comprising:
conditioning the processing pad after the processed substrate has been removed;
energizing the process cells by applying a voltage to the conditioned processing pad;
placing a second substrate on the energized pad; and
removing at least a portion of a conductive layer disposed on the second substrate in the energized cells.

14. The method of claim 13, wherein the step of applying a voltage further comprising:
applying a voltage to the pad between about 1 seconds and about 10 seconds prior to placing the second substrate on the pad.

15. The method of claim 13, wherein the step of removing at least a portion of the conductive layer disposed on the second substrate further comprises:
performing an in-situ conditioning process.

16. The method of claim 9, wherein the step of breaking in the pad further comprises:
contacting the conductive pad with a conditioning element comprising diamonds.

17. The method of claim 9, wherein the step of breaking the pad further comprises:
contacting a brush-type conditioning element to the conductive pad.

18. A method of polishing a substrate, comprising:
working conductive top surface of a conductive polishing pad to improve electrical properties;
establishing a current flow between worked top surface and an electrode through an electrolyte thereby defining at least one process cell;
placing a conductive surface of a substrate in contact with the cell;
adjusting the current flow through the cell; and
electrochemically processing the conductive surface.

19. The method of claim 18, wherein the step of adjusting processing current flow further comprises:
applying a lower voltage relative to a pre-processed voltage used to establish the current.

20. The method of claim 18 further comprising:
waiting for an in-rush current to subside prior to contacting the conductive surface of the substrate to the cell.
